(19) United States
(12) Patent Application Publication
(10) Pub. No.: US 2005/0257417 A1
(43) Pub. Date: Nov. 24, 2005

(54) Fishing rod holder

(76) Inventors: Leroy Black, Fairfax, MN (US); Rick R. Marks, Danube, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/938,092

(22) Filed: Sep. 10, 2004

Related U.S. Application Data
(60) Provisional application No. 60/572,303, filed on May 18, 2004.

(51) Int. Cl. A01K 97/10

(52) U.S. Cl. 43/21.2

(57) ABSTRACT

A molded holder for fishing rods supports the handle ends of a plurality of fishing rods in tubes, with reels on the rods on the exterior of the tubes. The holder has a plurality of support feet that support the holder. The entire holder, including the support feet, fit into a five gallon pail. A handle pole that extends above the pail is secured to the holder.

This application refers to and claims priority from U.S. Provisional Application Ser. No. 60/572,303, filed May 18, 2004, the contents of which are incorporated by reference.

### BACKGROUND OF THE INVENTION

The present invention relates to a fishing rod holder that goes inside of a standard pail from about four to ten gallons, usually about a five gallon pail, and which will hold rods erect, untangled, and easily accessible. The rod holder has a plurality of feet that rest on any surface and of size to rest on the floor of a pail, and upright tubes that hold the handle portions of a fishing rod, with a space radially outward from the tubes to accommodate reels. The rods extend upwardly, and can be fastened to a handle pole that protrudes out of the bucket or pail. The pail can be lifted then by the handle and carried away with the rods, without getting them tangled up.

In the prior art a fishing rod holder insert for a five gallon bucket is shown in U.S. Pat. No. 6,254,055. The insert has recesses or cutouts around the edges of two spaced plates to provide rest of supports for rods placed into a bucket.

Various ideas have been advanced for providing a way of holding fishing rods separated, and in some patents provide a way of carrying the rods and reels.

However, an easily made and efficient holder that can be used as a stand for storing rods and reels without tangling and also can be fitted into five-gallon buckets for transporting the rods and reels for use. The rod holder is primarily designed for ice fishing, but the holder can be used for use while fishing on water.

### SUMMARY OF THE INVENTION

The present invention relates to holder for fishing rods that have reels attached, and which holder will fit inside a standard pail. The holder also can be independently supported on a base.

The holder, as shown, comprises a molded base formed as a plurality of tubes centered around a central axis. The tubes are of size so that they will hold the handles of fishing rods, with attached reels to the exterior or extending radially outwardly from the tubes. The size of the rod holder is such that the base holding the fishing rods with attached reels will fit inside a pail, such as a standard five gallon pail. The base is supported on feet that are radially extending from the tubes at the lower or base end. The rod holder has a handle pole in a center recess that extends upwardly, and is preferably sectioned so that it can be broken down into short lengths for storage, as well as for ease of shipping.

The rod holder molded tubes are integrally held together, with molded feet that project outwardly, so that the base can be made economically from plastic material.

The handle pole that is used for carrying the rod holder also has a hook adjacent a top hand grip that is used for supporting and lifting the rod holder, and this hook is of size and is positioned to receive and support the bail or handle of the pail. Then, the pail, rod holder and supported rods and reels can be lifted as a unit for carrying to and from a fishing spot.

Ice fishing rods generally are relatively short, so that the length of the handle pole can be selected to be compatible with ice fishing rods, the primary intended use. Of course, other regular boat fishing rods can also be held and stored. The spaced tubes on the rod holder keeps the rods from becoming tangled, and holds them for storage in any location, as well as while transporting them in a pail.

### BRIEF DESCRIPTION OF THE DRAWINGS

FIG. 1 is a perspective view of a fishing rod holder base portion, made according to the present invention;

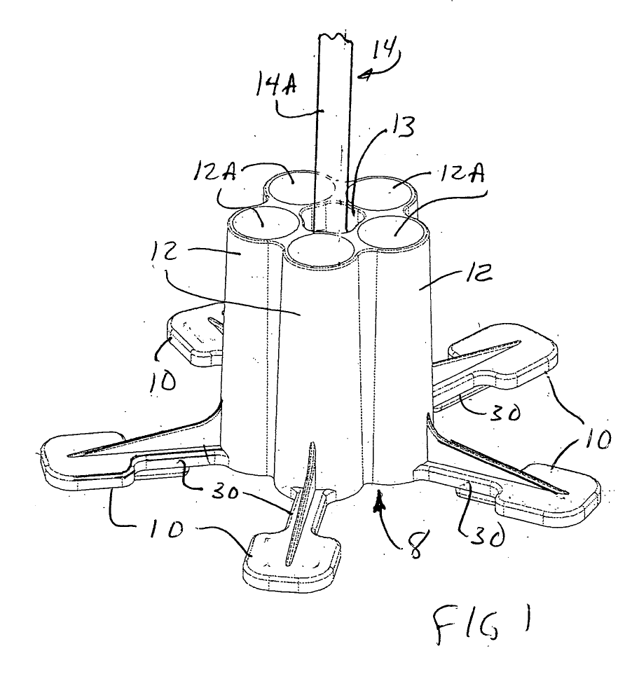

FIG. 2 is a perspective view of the rod holder with fishing rods and reels shown in place on rod holder tubes, and in a fragmentarily illustrated pail;

FIG. 3 is a view showing the fishing rod holder inside a pail, and showing that the feet of the rod holder fit inside the pail so that the bail or handle of the pail can be used to carry the rods;

FIG. 4 is a sectional view of the base taken along a diameter line;

FIG. 5 is a view of a modified handle with a threaded coupling for joining handle sections together and showing an attachment end for coupling to the rod holder base; and

FIG. 6 is a view showing a hook supporting the bail of pail in which the rod holder is placed so the pail and rod holder can be lifted as a unit by the center handle pole.

### DETAILED DESCRIPTION OF THE PREFERRED EMBODIMENTS

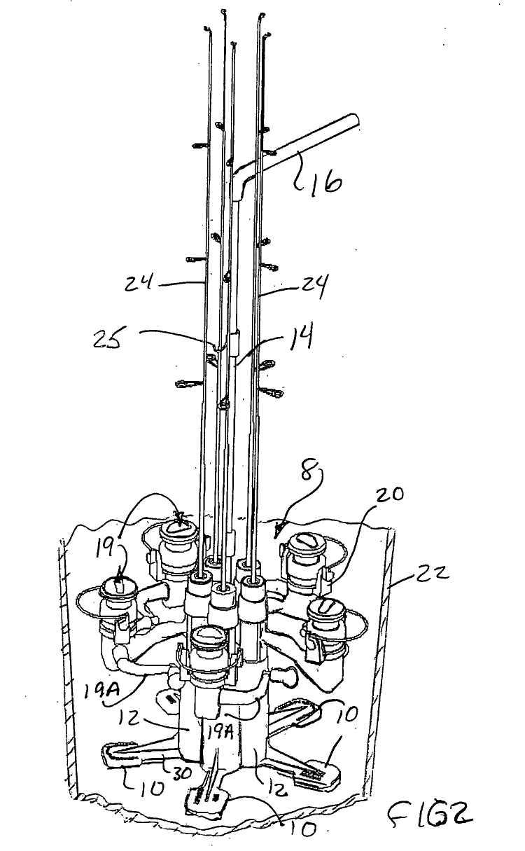

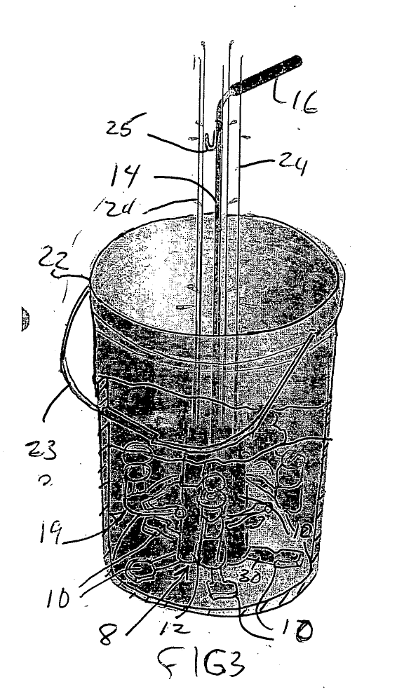

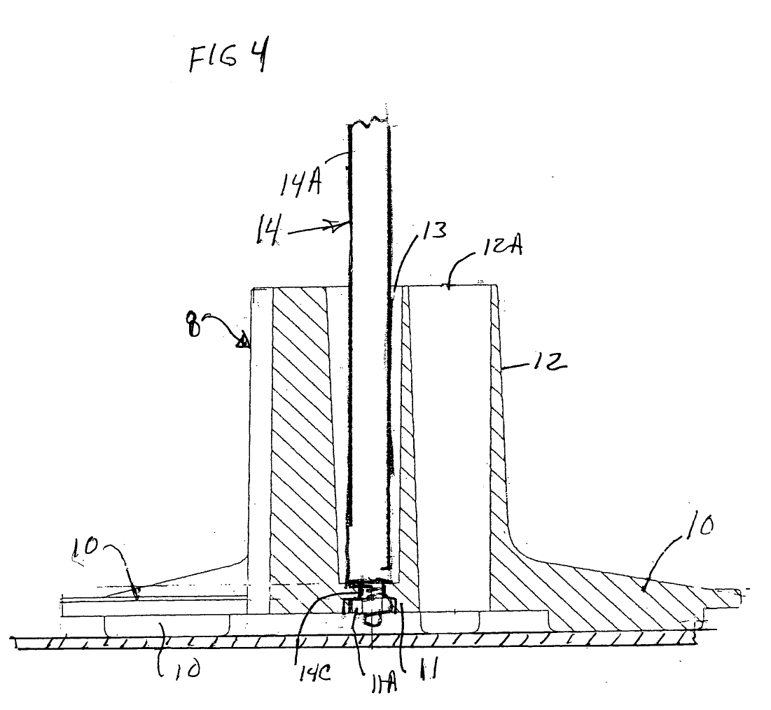

The holder for rods and reels is indicated at 8, and includes a molded base assembly of a plurality of outwardly extending feet or pads 10 that have a circumferential or peripheral size around a central upright axis of a standard pail or similar bucket such as a plastic utility pail that ranges in size from four gallons to ten gallons. A five gallon pail is presently a standard size pail. The holder 8 has a center base wall 11 (FIG. 4) and has five molded, upright tubes 12. The tubes 12 have central openings 12A of size to receive the handles of fishing rods, as shown in FIGS. 2 and 3.

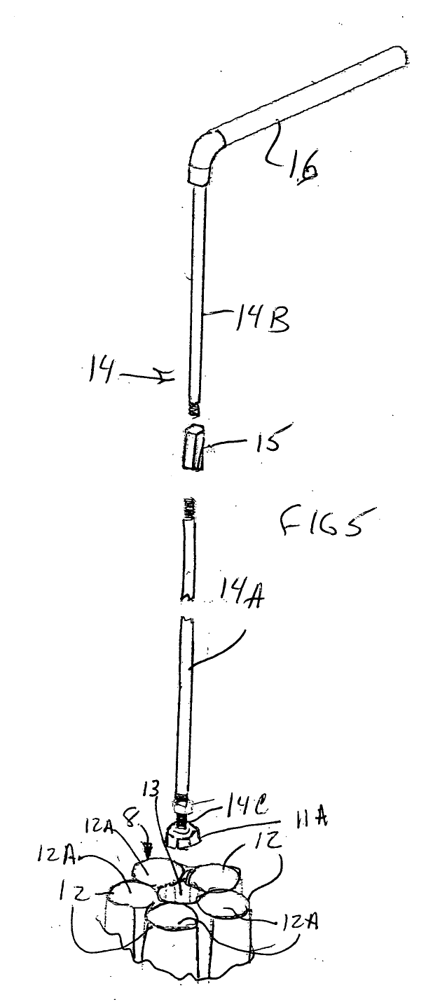

The tubes 12 are formed around a central axis of a center opening 13 in which a pole handle 14 can be secured to the base in any desired manner. The pole handle 14 has a threaded bolt or portion 14C (FIGS. 4 and 5) at its lower end that is held on wall 11 with a nut 11A on a lower side of base wall 11. The pole handle 14 can be multi-sectioned if desired as well and as shown in FIG. 5, the pole handle sections 14A and 14B can be held together by a threaded coupling 15. As shown, there are two sections 14A and 14B. The handle pole 14 has a comfort hand grip 16 at an angled upper end.

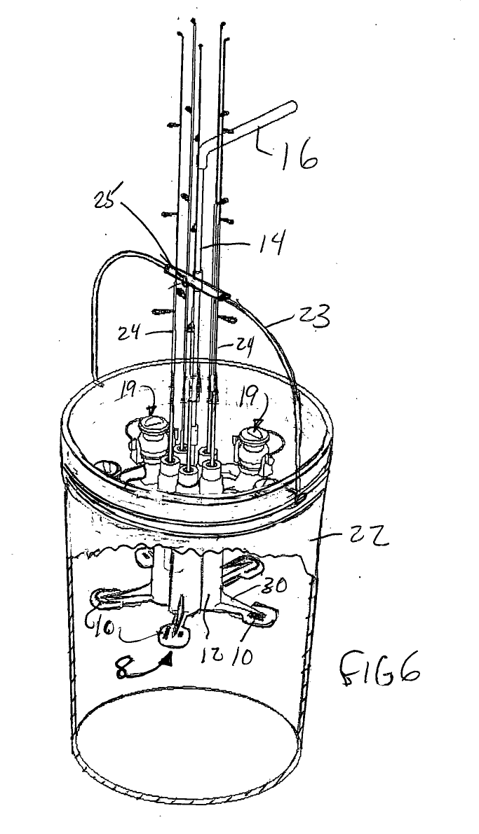

Referring to FIGS. 2 and 3, where there is a pail or bucket 22 shown, the hand grip 16 extends above the upper end of pail 22 as can be seen. The hand grip 16 is used for lifting the handle pole 14 and attached rod holder 8 out of the pail 22 and carrying the rod holder separately from the bucket, or also carrying the pail, as shown in FIG. 6.

When the bail or handle 23 of the pail 22 is supported on a hook 25 fixed on an upper end of the handle pole 14, the pail, rod holder and rods and reels can be lifted as a unit.

FIG. 3 illustrates a plurality of rods and reels 19, with the rod handles inside the holder tubes 12, and with the reels 20 and reel cranks 19A extending outwardly, to the outside of the tubes 12. As can be seen in FIGS. 3 and 4, the pail 22 is of sufficient size so that the reels 20 can fit inside the circumference of the pail. The reels 20 are contained in the bucket. The rods 24 extend upwardly adjacent the upright handle pole 14. Suitable devices can be used for securing the rods to the upright handle pole, if desired, such as plastic grippers, elastic bands, or the like.

The feet or pads 10 are on molded arms 30 that extend outwardly from the five molded tubes 12. The arms 30 can be reinforced as needed. The tubes 12 are joined together around the central opening 13 at the center of tubes 12, which is where the handle pole 14 is placed and secured.

In FIG. 5, the handle pole 14 is shown in two sections including a base section 14A and an upper handle section 14B. The two sections are threadably held together with the coupling 15. The sections can be threaded together for use as a lift handle pole, and separated for storage and shipping.

For carrying the pail 22 with the rod and rods and reels holder in place, a hook 25 is fixedly mounted near the top of handle pole 14 adjacent the hand grip 16, and in position to receive the bail or handle 23 of the pail 22. The hook 25 is positioned so that when the pads 10 are on the floor of the pail 22, the bail or handle 23 will slip over the hook. The handle pole 14 can be lifted and the bail 23 fits down into hook 25. The pads 10 will lift off the floor of the pail as the bail 23 seats on the hook 25. The handle grip 16 can then be used to lift both the rod holder and the pail as a unit. The fishing rods are removed in FIG. 6 to show the hook. The rods deflect as needed to place the bail 23 on the hook 25.

The base section 14A of the handle pole 14 has a threaded end 14C, as shown, that extends through an opening in the center of the base wall 11 and is held with a nut 11A on the bottom of the base wall 11 of the rod holders.

The rod holder 8 presents ease of inserting the rod handles with the reels attached without getting the reels and rods entangled. The rods can also be easily removed for use.

The rod holder is stable when free standing, so it can be used for storing the rods and reels at any location.

Although the present invention has been described with reference to preferred embodiments, workers skilled in the art will recognize that changes may be made in form and detail without departing from the spirit and scope of the invention.

1. A fishing rod holder for a plurality of fishing rods comprising a base having an outer circumference that is of size to fit within a desired size open top pail, a plurality of upright tubes on the base for holding handles of a rod and reel, and a central upright pole that extends upwardly above the upright tubes, the tubes being oriented around the central upright pole and permitting a reel on a fishing rod in a tube to extend outwardly therefrom and be positioned inside a supporting pail.

2. The fishing rod holder of claim 1 wherein the base has a plurality of support feet extending outwardly from the tubes, the support feet fitting within the desired size pail.

3. The fishing rod holder of claim 1 wherein the upright tubes are molded together as a unit.

4. The fishing rod holder of claim 2 wherein the upright tubes and support feet are molded as a unit.

5. The fishing rod holder of claim 4 wherein the central upright pole is formed in at least two separable sections.

6. The fishing rod holder of claim 1 wherein an upper end of the central upright pole has an offset hand grip.

7. The fishing rod holder of claim 1, and a hook on the central upright pole to receive a bail of a pail in which the fishing rod holder is placed.

8. A fishing rod holder and open top carrying pail combination for holding and carrying a plurality of fishing rods comprising a base having an outer circumference that is of size to fit within the open top pail, a plurality of upright tubes each for holding a handle of a rod and reel, and a central upright handle pole that extends upwardly above the tubes at an upper end thereof, the tubes permitting reels on fishing rods to extend outwardly therefrom and remain inside the pail.

9. The combination of claim 8, the pail comprises a pail of between four and ten gallons in size and wherein the base has a plurality of support feet extending outwardly from upright tubes, the feet fitting within the pail.

10. The combination of claim 8, wherein the upright tubes are molded tubes.

11. A fishing rod holder for a plurality of fishing rods comprising a base, a plurality of upright tubes on the base for holding handles of rods and reels, and a central upright pole that extends upwardly above the upright tubes, the upright tubes being oriented around the central upright pole and permitting reels on fishing rods in the tubes to extend outwardly therefrom.

12. The fishing rod holder of claim 11, wherein the base has a plurality of support feet extending outwardly from the tubes.

13. The fishing rod holder of claim 11, wherein the upright tubes and the support feet are molded together as a unitary structure.

14. The fishing rod holder of claim 13, wherein the upright tubes and support feet are dimensioned to fit into a selected size pail.
